(19) United States
(12) Patent Application Publication
(10) Pub. No.: US 2020/0097260 A1
(43) Pub. Date: Mar. 26, 2020

(54) SOFTWARE APPLICATION DEVELOPER TOOLS PLATFORM

(71) Applicant: salesforce.com, inc., San Francisco, CA (US)

(72) Inventors: Mary Elizabeth Clarke, Oakland, CA (US); Mindaugas Idzelis, Morrisville, NC (US); Kris Gray, Redmond, WA (US); Ryan Ellis, Santa Monica, CA (US); Pierre-Marie Dartus, San Francisco, CA (US)

(21) Appl. No.: 16/378,327

(22) Filed: Apr. 8, 2019

Related U.S. Application Data
(60) Provisional application No. 62/735,752, filed on Sep. 24, 2018.

(51) Int. Cl. G06F 8/33; G06F 8/41

(52) U.S. Cl. CPC G06F 8/33; G06F 8/427; G06F 8/436; G06F 8/423

(57) ABSTRACT

A system for a computer application software developer has been developed. The system includes a local computer system with a computer readable electronic data storage media with a browser located on the local computer system. An application tools platform is stored on the browser that includes a computer software code compiler for use by the computer application software developer.

### CROSS-REFERENCE TO RELATED APPLICATION(S)

This application claims the benefit of United States provisional patent application Ser. No. 62/735,752 filed on Sep. 24, 2018 entitled “Software Application Developer Tools Platform”.

### TECHNICAL FIELD

Embodiments of the subject matter described herein relate generally to software development tools. More particularly, embodiments of the subject matter relate to software application developer tools platform that is located on a local computer system's browser.

### BACKGROUND

As software development gets more complex and involved, developers have a definite need for tools that provide simplicity and ease of reliable use. Accordingly, it is desirable to have a software application developer tools platform that is located on a local computer system's browser.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram of an exemplary multi-tenant computing environment in accordance with one embodiment;

FIG. 2 is block diagram of a computer system for a developer tools platform in accordance with one embodiment; and

FIG. 3 is an example of a dashboard display for a developer tools platform in accordance with one embodiment.

### DETAILED DESCRIPTION

A software application developer tools platform has been developed. The tools platform provides a software application developer the ability to easily create, compile and debug code for an application. The tools platform is tailored for and allows embedding in different versions of various programming languages. In some embodiments, the tools platform is built on a Java Script framework. A key feature of the tools platform is that all features are local and located in a file browser. This allows for ease-of-use by allowing the developer to work off-line. Since everything in the tools platform runs in the browser, no server is involved in the running of the tools platform. In alternative embodiments, the tools platform is based on a metadata-driven and multi-tenant cloud architecture.

The advantage to working offline is that is not necessary to log into the cloud (i.e., no user id required), or perform time-consuming deployments to see changes reflected in the system. This significantly speeds iterative development since changes can be seen without deployments. During deployment, the same code will work without modifications against real data. When creating applications are created that need data from the server, it is possible to mock out this data so that it works offline. Later, during deployment, the real data is swapped in, instead of using mock data.

In one exemplary embodiment, the tools platform is used to support the Lightning Application Development Platform of Salesforce.com (the “Lightning Platform”). It delivers out-of-the-box tools and services to automate business processes, integrate external applications and provide responsive layouts. For users, the Lightning Platform is a metadata-driven and multi-tenant cloud architecture. The Lightning Platform provides easy ways to create, build and customize entire apps with tools such as App Builder and Community Builder as well as frameworks like Apex. Apex is an object-oriented language that has application programming interfaces (APIs) for creating, compiling and debugging code. The Lightning Component Framework uses Apex on the server side and JavaScript on the client side. Drag and drop components are used in Lightning App Builder to design desktop and mobile apps. No-code integration capabilities like Salesforce Connect and the new External Services Wizard may be used to immediately link multiple systems. Alternatively, a comprehensive suite of REST and SOAP APIs may be used for specialized integration demands.

In some embodiments, the “tooling platform” can feature multiple users editing the same project, without conflicts. Each time a project is “saved”, it gets its own immutable uniform resource locator (URL). These users may also concurrently edit the same source code file, by using a code editor. The users may also ‘share’ one of these projects with other users on the internet using a URL.

In other embodiments, a super-lightweight version of the tooling platform may be embedded into external sites, like blogs, learning platforms, documentation sites, or any other web-accessible resource. The platform may be opened by clicking a link to the full tooling platform from within the embedded version.

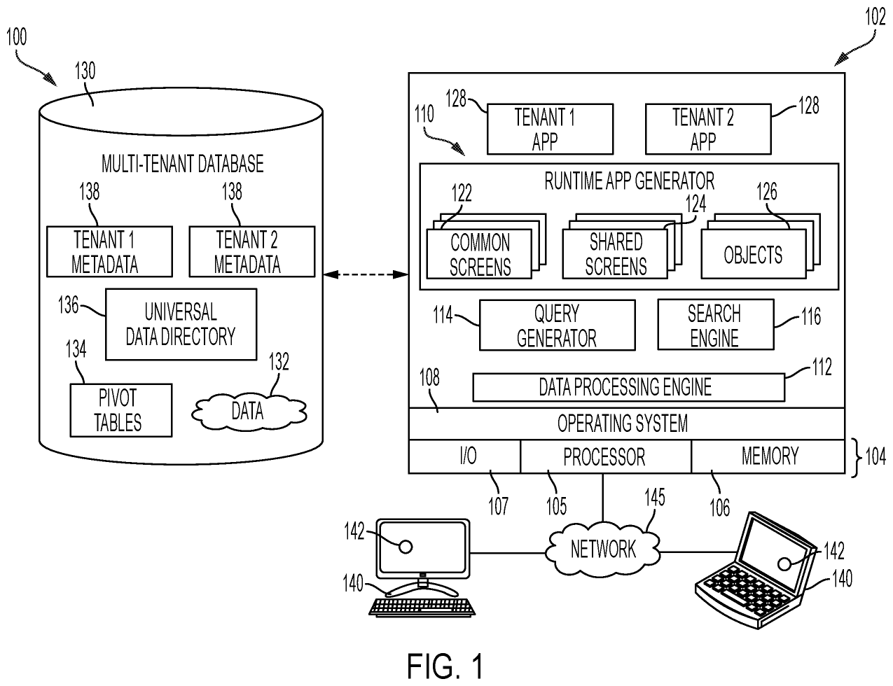

The disclosed embodiments described below may be implemented in a wide variety of different computer-based systems, architectures and platforms which may include a multi-tenant system. Additionally, the disclosed embodiments may be implemented using mobile devices, smart wearable devices, virtual systems, etc. Turning now to FIG. 1, an exemplary multi-tenant system 100 includes a server 102 that dynamically creates and supports virtual applications 128 based upon data 132 from a database 130 that may be shared between multiple tenants, referred to herein as a multi-tenant database. Data and services generated by the virtual applications 128 are provided via a network 145 to any number of client devices 140, as desired. Each virtual application 128 is suitably generated at run-time (or on-demand) using a common application platform 110 that securely provides access to the data 132 in the database 130 for each of the various tenants subscribing to the multi-tenant system 100. In accordance with one non-limiting example, the multi-tenant system 100 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 130. In this regard, each tenant includes one or more users associated with, assigned to, or otherwise belonging to that respective tenant. Stated another way, each respective user within the multi-tenant system 100 is associated with, assigned to, or otherwise belongs to a particular one of the plurality of tenants supported by the multi-tenant system 100. Tenants may represent companies, corporate departments, business or legal organizations, and/or any other entities that maintain data for particular sets of users (such as their respective customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other tenants.

The multi-tenant database 130 may be a repository or other data storage system capable of storing and managing the data 132 associated with any number of tenants. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein. In an exemplary embodiment, the database 130 includes a database management system or other equivalent software capable of determining an optimal query plan for retrieving and providing a particular subset of the data 132 to an instance of virtual application 128 in response to a query initiated or otherwise provided by a virtual application 128, as described in greater detail below. The multi-tenant database 130 may alternatively be referred to herein as an on-demand database, in that the multi-tenant database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like. The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below. Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

A “browser” is an application program that provides a way to look at and interact with information. More specifically, a “file browser”, sometimes called a “file manager”, is a program that provides a user interface to manage files and folders. The most common operations performed on files or groups of files include creating, opening (e.g. viewing, playing, editing or printing), renaming, moving or copying, deleting and searching for files, as well as modifying file attributes, properties and file permissions. Folders and files may be displayed in a hierarchical tree based on their directory structure. Some file managers contain features inspired by web browsers, including forward and back navigational buttons.

A file browser typically has multiple windows. One type of the window is called a panel and is typically positioned at the top of the screen. The second type is the command line, which is essentially a minimized command (shell) window that can be expanded to full screen. Only one of the panels is active at a given time. The active panel contains the “file cursor”. Panels are resizable and can be hidden. Files in the active panel serve as the source of file operations performed by the manager. For example, files can be copied or moved from the active panel to the location represented in the passive panel. Users may customize the display of columns that show relevant file information. The active panel and passive panel can be switched. The use of tabbed panels in some file browser allow the manipulation of more than one active and passive directory at a time.

Typical file browsers may present the user with a two-panel directory view with a command line below. Either panel may be selected to be active; the other becomes passive. The active panel becomes the working area, while the passive panel serves as a target for other operations. Panels may be shrunk or expanded. The browser may provide the user with extensive keyboard shortcuts and thus free the user from having to use the mouse. Users may create their own file associations and scripts that are invoked for certain file types and organize these scripts into a hierarchical tree (e.g., as a user script library or user menu). Other common features of a browser may include: information on the “active” and “passive” panels for constructing commands on the command line (e.g., current file, path to left panel, path to right panel, etc.); a built-in viewer for (at least) the most basic file types; a built-in editor that can extract certain elements of the panels into the text being edited; support for virtual file systems (VFS) such as viewing compressed archives, or working with files via an FTP connection; showing the source/destination location of the directory path in use; a panel showing information about number of files in directory, the sum of the sizes of selected files, directory size, disk usage and disk name; providing a panel with information about file name, extension, date and time of creation, last modification, and permissions (attributes).

A “compiler” is a computer program that transforms or translates computer code written in one programming language (the source language) into another programming language (the target language). Compilers are primarily used for programs that translate source code from a high-level programming language to a lower level language (e.g., assembly language, object code, or machine code) to create an executable program. A compiler is likely to perform many or all of the following operations: preprocessing, lexical analysis, parsing, semantic analysis (syntax-directed translation), conversion of input programs to an intermediate representation, code optimization and code generation. Compilers implement these operations in phases that promote efficient design and correct transformations of source input to target output. Program faults caused by incorrect compiler behavior can be very difficult to track down and work around; therefore, compiler implementers invest significant effort to ensure compiler correctness.

One feature of the tools platform is that it allows avoiding needing to file, set permissions or all the dependencies correctly. A “dependency” or “coupling” is the degree to which each program module relies on each one of the other modules. Additionally, most file systems have methods to assign “permissions” or “access rights” to specific users and groups of users. These permissions control the ability of the users to view, change, navigate, and execute the contents of the file system.

All elements of the process of working with development components has been simplified. These elements of the tools platform include the following advantages: immediate compiling allows immediate preview of changes; keeping all files and sources in the same location; and all tools and features are located completely in the browser including the compiler.

The tools platform allows a semantic review. “Semantic review”, “semantic analysis” or “context sensitive analysis” is a process in compiler construction, usually after parsing, to gather necessary semantic information from the source code. It usually includes type checking, or makes sure a variable is declared before use since it is not easily detected during parsing. Semantic analysis is made at compile time in most compilers, and its purpose is to check, whether or not your code satisfies programming language specification. It also checks type correctness, method existence and so on. The tools platform generates an error display for the use. Additionally, “versioning” is allowed in the browser's compiler which lets the user to see the output of many versions of software code.

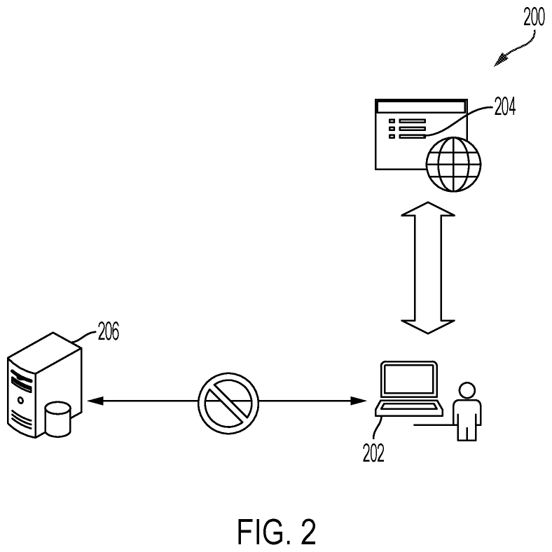

Turning now to FIG. 2, a diagram is shown of a computer system 200 for a developer tools platform in accordance with one embodiment. In this embodiment, a local computer system 202 is available to a user such as a computer application software developer. The computer system 202 contains a browser 204 that is stored on the electronic data storage media of the computer 202. The application tools platform is located completely within the browser 204. This allows the user to utilize the tools platform locally while being completely off-line from a database server 206. All features are contained, executed and stored within the browser 204.

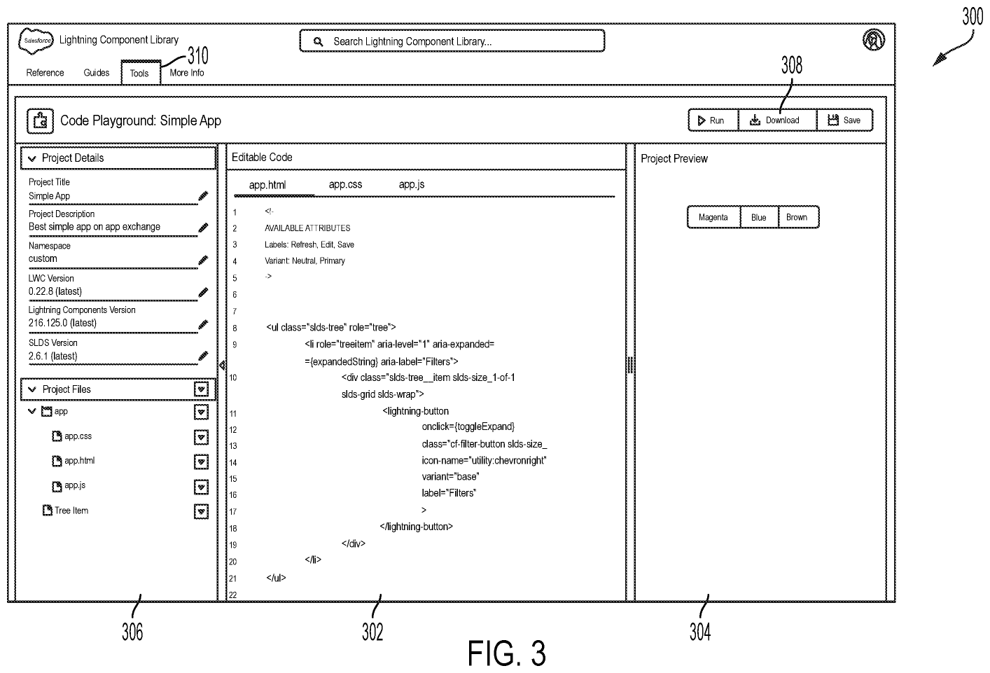

Turning now to FIG. 3, an example is shown of a dashboard display 300 for a developer tools platform in accordance with one embodiment. The dashboard display 300 includes 3 separate panel displays: an editable code panel 302; a project preview panel 304; and a project details panel 306. The editable code panel 302 displays the code that is being written and edited by the developer. The project preview panel 304 shows details of the project while the project details panel 306 shows details such as the projects title, description version and file tree. Also shown are a command line 308 and a set of tab panels 310.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

“Node/Port”—As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node). As used herein, a “port” means a node that is externally accessible via, for example, a physical connector, an input or output pin, a test probe, a bonding pad, or the like.

“Connected/Coupled”—The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic depicts one exemplary arrangement of elements, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed may be performed by software, hardware, firmware, or any combination thereof. For illustrative purposes, the following description may refer to elements mentioned above. In practice, portions may be performed by different elements of the described system, e.g., component A, component B, or component C. It should be appreciated that the process may include any number of additional or alternative tasks, the tasks need not be performed in the illustrated order, and the process may be incorporated into a more comprehensive procedure or process having additional functionality not described in detail herein. Moreover, one or more of the tasks could be omitted from an embodiment of the process as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A system for a computer application software developer, comprising:
a local computer system with a computer readable electronic data storage media;
a browser that is stored on the electronic data storage media of the local computer system; and
an application tools platform that is stored on the browser, where the application tools platform includes a computer software code compiler for use by the computer application software developer.

2. The system of claim 1, where the application tools platform is built on a Java Script framework.

3. The system of claim 1, where the applications tools platform allows the computer application software developer to create code for a software application.

4. The system of claim 3, where the computer software code compiler immediately compiles the code created by the computer application software developer.

5. The system of claim 4, where the application tools platform allows an immediate preview of the changes of the compiled code created by the computer application software developer.

6. The system of claim 3, where the application tools platform allows the computer application software developer to debug the code.

7. The system of claim 3, where the application tools platform allows the computer application software developer to conduct a semantic review of the code.

8. The system of claim 3, where the application tools platform contains an error display for the computer application software developer.

9. The system of claim 3, where the application tools platform stores all files created by the computer application software developer on the computer readable electronic data storage media located on the local computer system.

10. The system of claim 3, where the computer software code compiler generates and displays the outputs of multiple versions of the code.

11. The system of claim 1, where the local computer system, the browser and the application tools platform work off-line from a database server.

12. The system of claim 1, where the local computer system comprises a mobile device.

13. A computer readable storage media comprising:
a computer readable electronic data storage media with stored computer instructions to implement, a browser that is stored on the electronic data storage media of the local computer system; and
an application tools platform that is stored on the browser, where the application tools platform includes a computer software code compiler that immediately compiles software code written by a computer application software developer.

14. The storage media of claim 13, where the application tools platform allows an immediate preview of the changes of the compiled code created by the computer application software developer.

15. The storage media of claim 13, where the application tools platform allows the computer application software developer to debug the code.

16. The storage media of claim 13, where the allows the computer application software developer to conduct a semantic review of the code.
